(19) United States
(12) Patent Application Publication
(10) Pub. No.: US 2024/0282205 A1
(43) Pub. Date: Aug. 22, 2024

(54) SYSTEM AND METHODS FOR YOUTH CAREER DEVELOPMENT, WORK-READINESS, INCOME GENERATION AND FINANCIAL MANAGEMENT WITH ARTIFICIAL INTELLIGENCE AND MACHINE LEARNING

(71) Applicant: Electus Global Education Co, Inc., Tampa, FL (US)

(72) Inventor: Kamal MOUMNEH, Tampa, FL (US)

(73) Assignee: Electus Global Education Co, Inc., Tampa, FL (US)

(21) Appl. No.: 18/441,144

(22) Filed: Feb. 14, 2024

Related U.S. Application Data
(60) Provisional application No. 63/485,343, filed on Feb. 16, 2023.

(51) Int. Cl. G09B 5/02; G06Q 50/20; G09B 7/00

(52) U.S. Cl. CPC G09B 5/02; G06Q 50/2057; G09B 7/00

(57) ABSTRACT

Systems and methods may be described herein that utilize adaptive learning and teaching that, in part, can capture data to analyze, curate, modify, present, personalize, and visualize career development, work-readiness and financial management learning material and content based on user's historical engagements, preferences and performances to achieve optimal learning content individualization, adaption and customization.

### BACKGROUND

Career development is a lifelong process of self-exploration, discovery, awareness, adaptation, growth and continual acquisition of knowledge and decision-making skills in the ever-changing world of work. Career development in the early years is a process that helps young people discover who they are with the core outcome being self-construction. Young people actively explore their worlds and begin to construct possibilities for their present and future selves. These life affairs lead to self-identify, life roles, skills, knowledge and are shaped by everyday events, learnings, and experiences, as well as by developed interests, attitudes, beliefs, and life aspirations.

Work-readiness are personal, interpersonal, and professional capabilities necessary for young people to gain and maintain employment, preparing new generations to enter the workforce. Young people can develop these skills and traits before going into the workforce to help them identify and select suitable professional, trade, career paths, as well as find desired jobs and employment. A person can apply work readiness skills to any job or career, so it's very important to develop them early in life and continuously throughout their career spans. Additionally, young people will be more motivated to develop work-readiness skills and behaviors if they have precise goals and ideas for their future.

The job market has changed dramatically over the past 20 years. Many young people today, particularly those from disadvantaged backgrounds, find it increasingly difficult to make a successful transition from education to employment because, in part, young people do not have the ability to adequately and effectively explore, through experimentation, trials and scouting to discover and select the suitable career paths for proper career training and then acquire the associated work-readiness and workplace skills, knowledge, and behaviors they need to succeed in the job market and life today.

Additionally, young people learning how to work to generate income and earn real money and manage their real-world finances provides them a foundation and understanding that employment, jobs, career, work and money and income are inextricably connected. Young people learn the concept that money is scarce and is the reward for working and being employed, and that the money earned, helps them acquire the resources they require for their needs and wants as well as to achieve financial goals and life aspirations.

However, one of the problems is the lack of suitable and effective technological systems, tools, and methods to harmonize and functionally integrate real-world experiential learn-to-earn, work-to-earn, income and earnings generation, and financial management capabilities with experiential career development and work-readiness learning and training for young people. Additionally, presently, there are no systems and methods that integrate and deploy prescriptive analytics, predictive analytics, Artificial Intelligence (AI) and Machine Learning (ML) that allow young people to experiment, explore, discover, and then initiate an optimally prescribed career paths and then predict their career and work-readiness success effectively and accurately through the integration, consolidation and optimization of real-world work-to-earn, income, and earnings generation and financial management experiential learning systems and methods with career development and work-readiness learning systems.

### SUMMARY

In an exemplary embodiments, systems and methods for career development, work readiness, income generation and financial management may be provided. In some embodiments user actions, activities, engagements, performances, and preferences may be fed into the system. User's income and earning generation performances, interests, inspirations, skills, knowledge, behaviors, goals, and future perspectives may be analyzed in order to determine alignment and positioning of the user's current career path. A database may be utilized to determine if the user career path alignment and positioning match with their planned career path. If career path alignment and positioning match then the current career path may be maintained. If career path alignment and positioning do not match and are in misalignment, a career path shift may be initiated. Regardless of which path is taken, continuous real-time analysis may be implemented in order to continually monitor the user's performance and progress on their chosen career path. If a career path shift is determined to be suitable and beneficial, prescriptive analytics, AI or ML may be utilized to analyze and make determinations and/or and recommendations of alternate learning content that may be utilized by the user, which may be fed into a content database that contains information on the user's past and new career path. The method may then continually analyze the user's engagement, performance, and preferences.

### BRIEF DESCRIPTION OF THE FIGURES

Advantages of embodiments of the present invention will be apparent from the following detailed description of the exemplary embodiments. The following detailed description should be considered in conjunction with the accompanying figures in which:

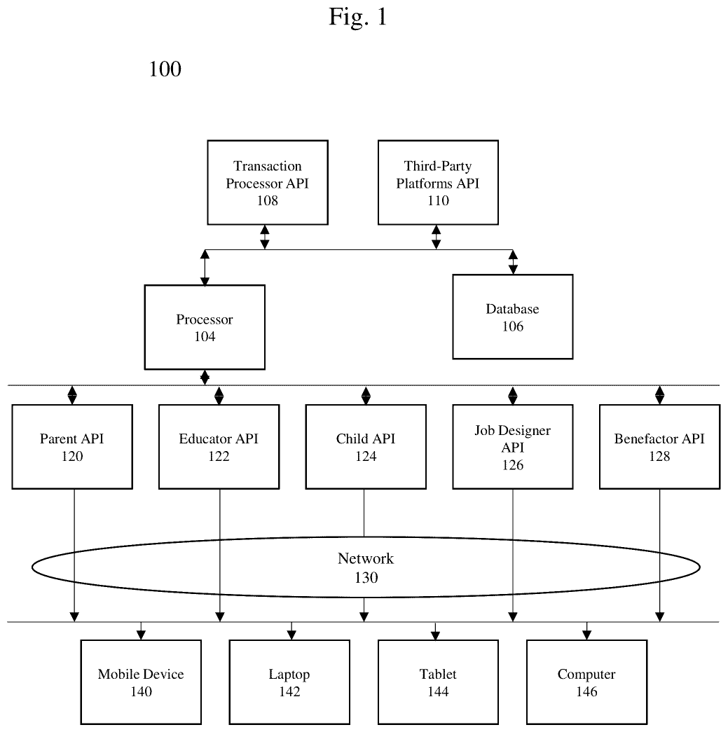

Exemplary FIG. 1 shows an exemplary educational micro jobs system.

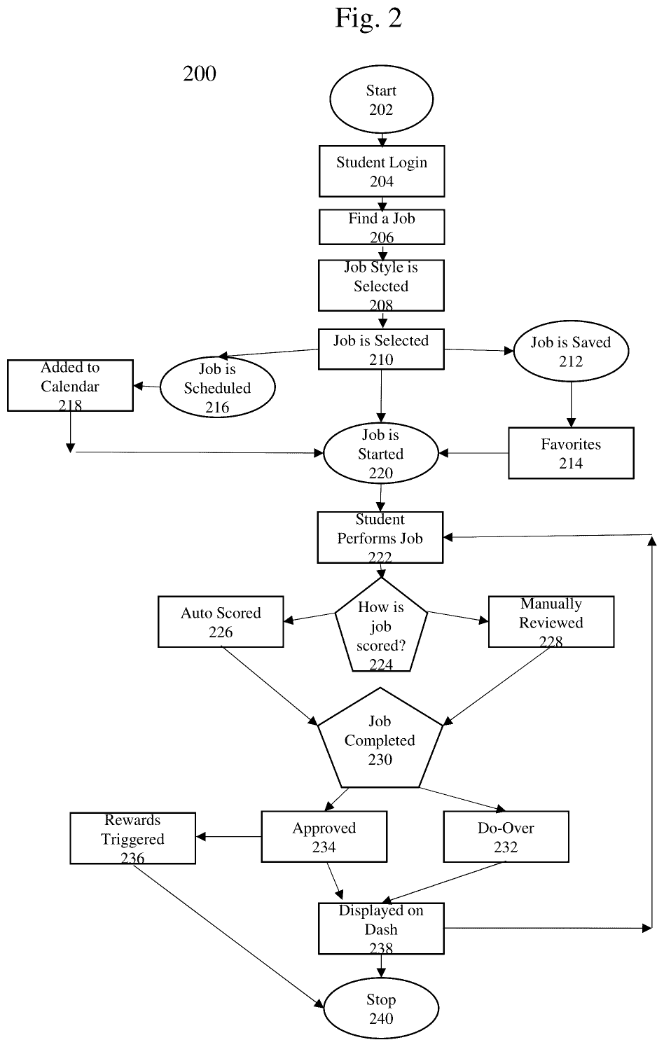

Exemplary FIG. 2 shows an exemplary process and operations flowchart.

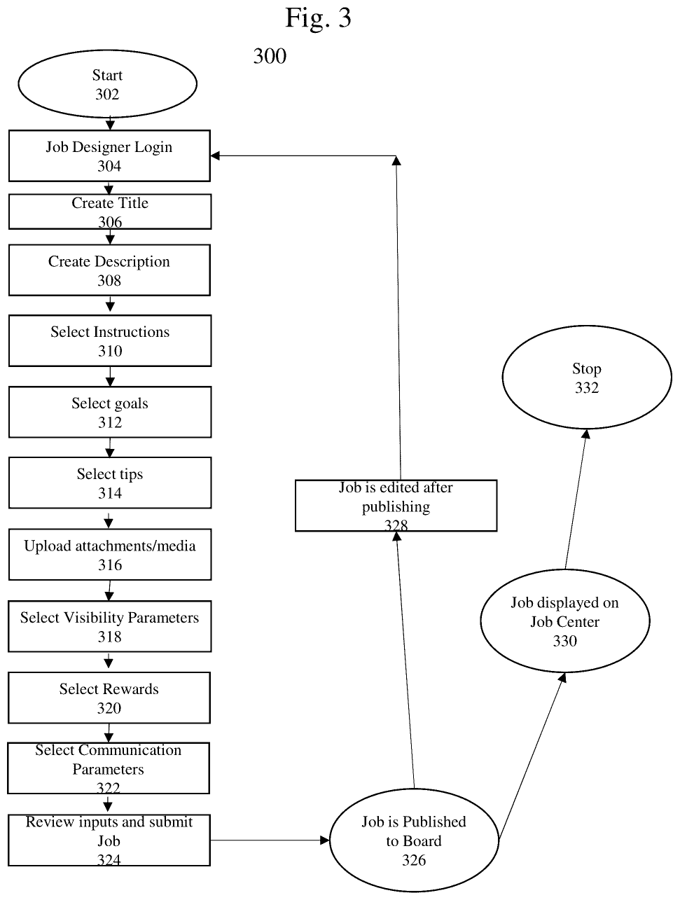

Exemplary FIG. 3 shows an exemplary flowchart for designing, creating, and publishing productivity educational micro jobs.

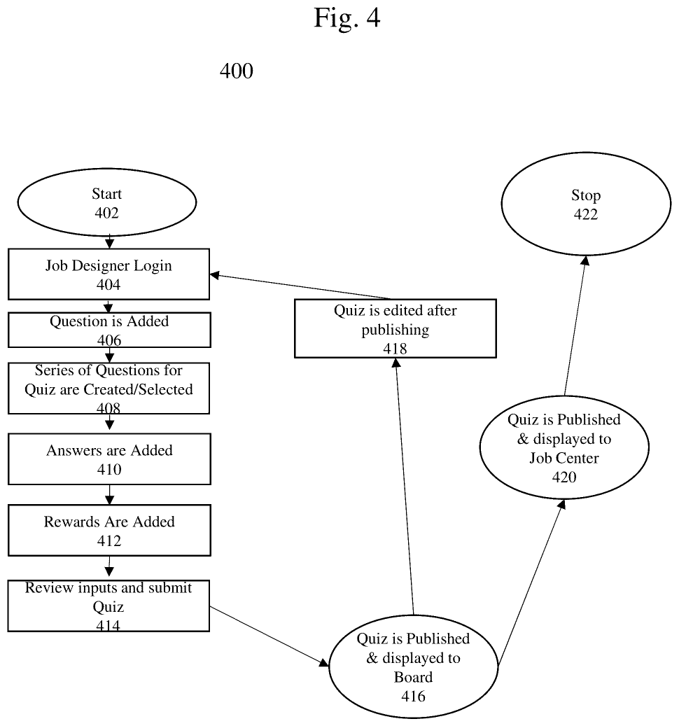

Exemplary FIG. 4 shows an exemplary flowchart for designing and publishing quiz educational micro jobs.

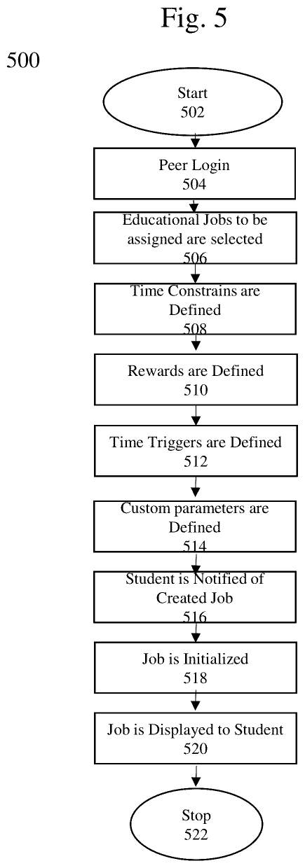

Exemplary FIG. 5 shows an exemplary flowchart for assignment, payment, rewarding, and management of educational micro jobs.

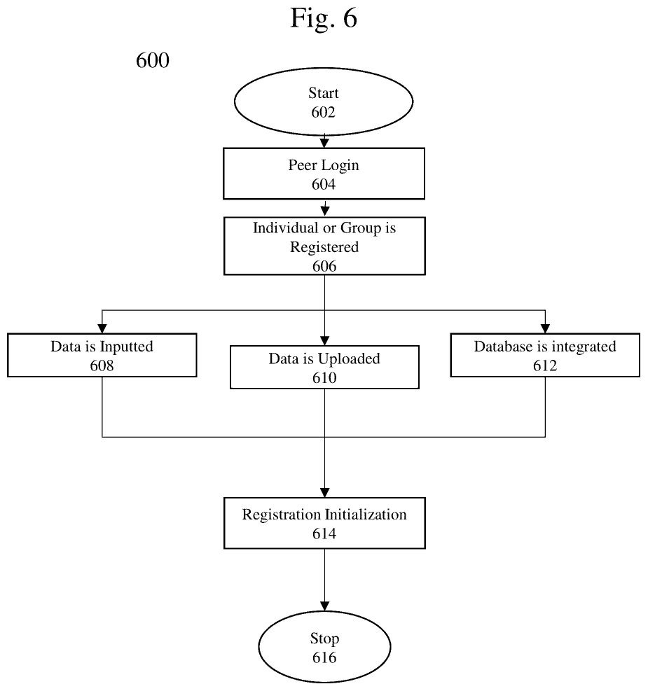

Exemplary FIG. 6 shows an exemplary flowchart shows an exemplary flowchart for registering a student.

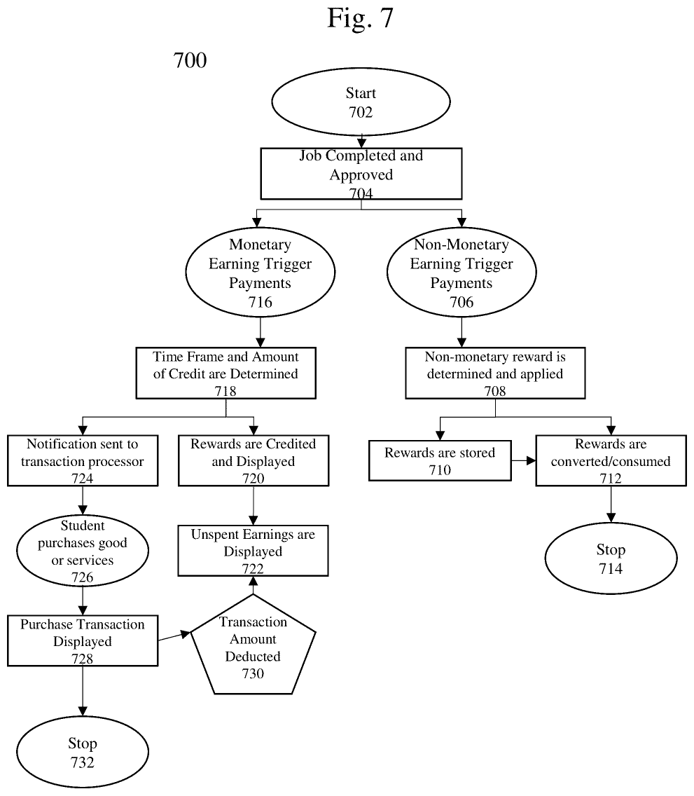

Exemplary FIG. 7 shows an exemplary process and operations flowchart for triggering, crediting, storing, and managing student earnings.

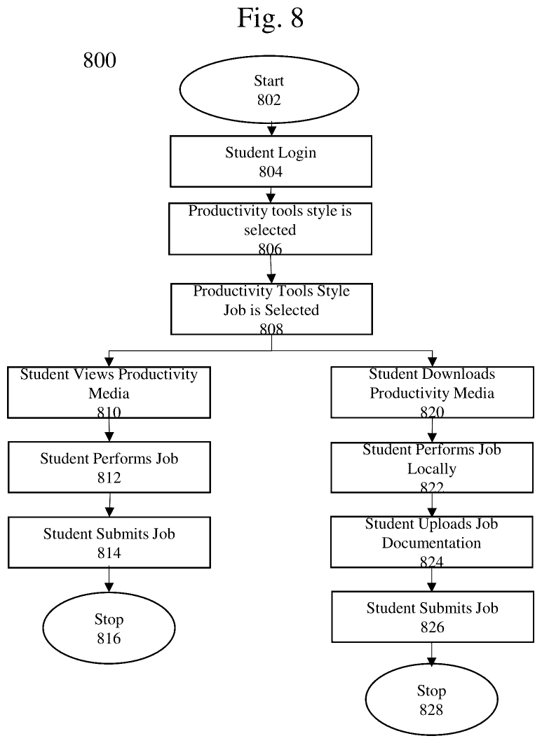

Exemplary FIG. 8 shows an exemplary process and operations flowchart for evaluating productivity style performance.

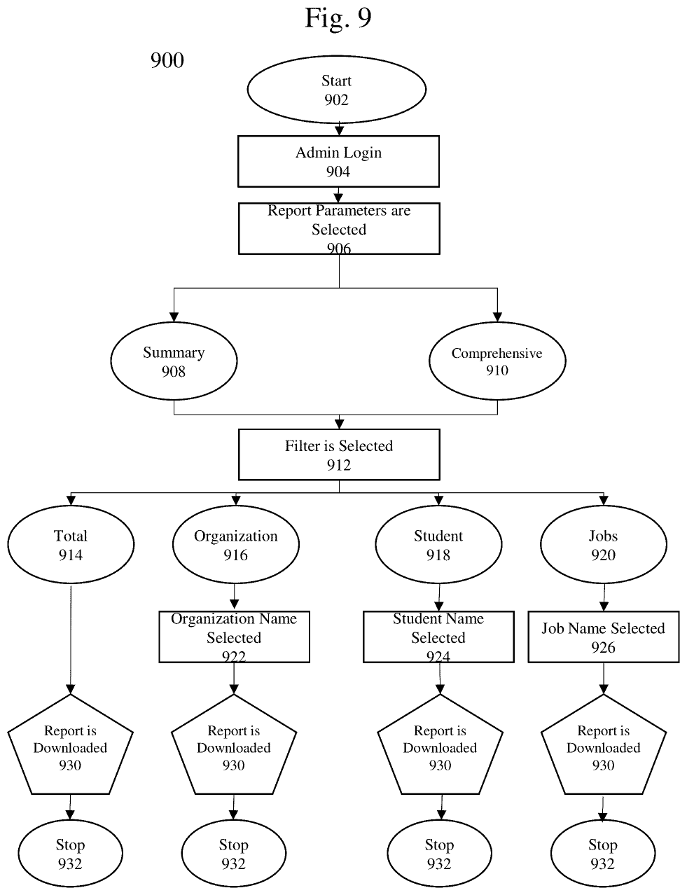

Exemplary FIG. 9 shows an exemplary flowchart for generating and downloading summaries and comprehensive reports.

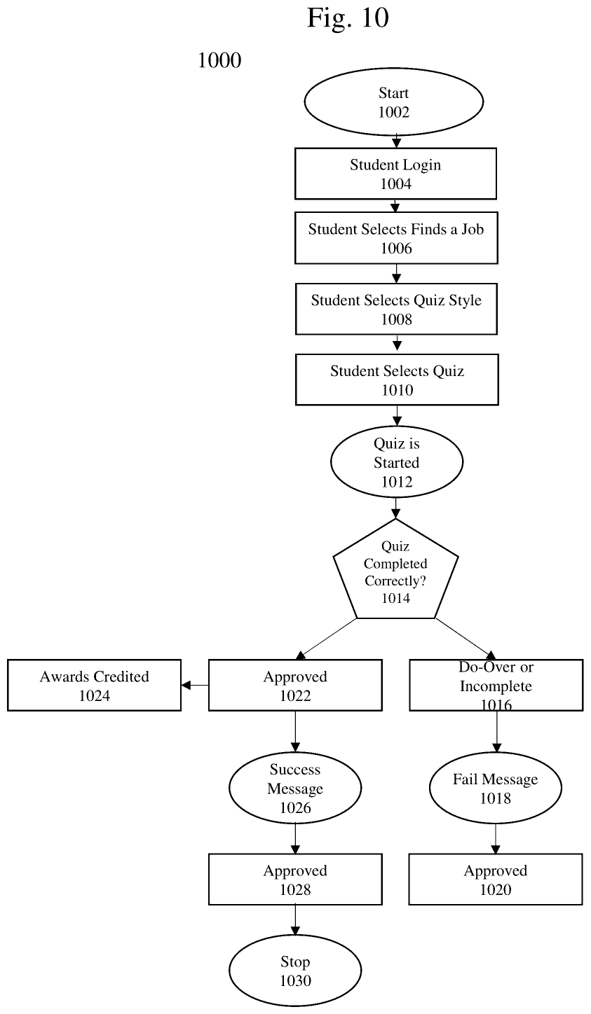

Exemplary FIG. 10 shows an exemplary process and operations flowchart for evaluating performance of quiz education micro jobs.

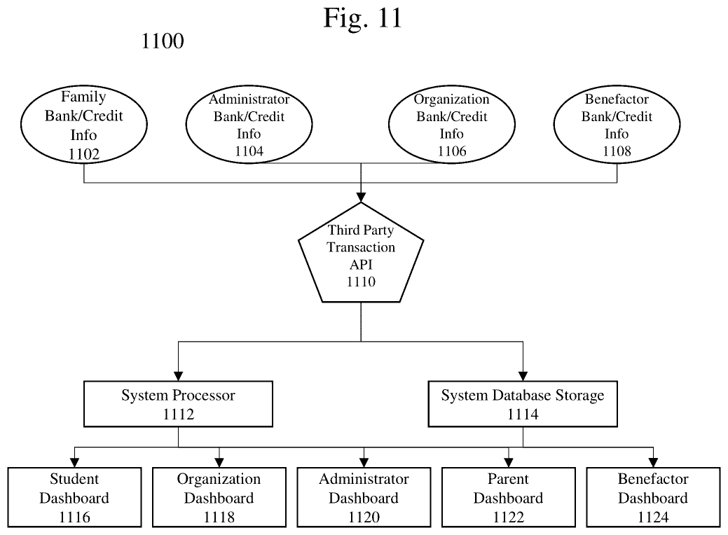

Exemplary FIG. 11 shows an exemplary system for digital transfer of cash or money.

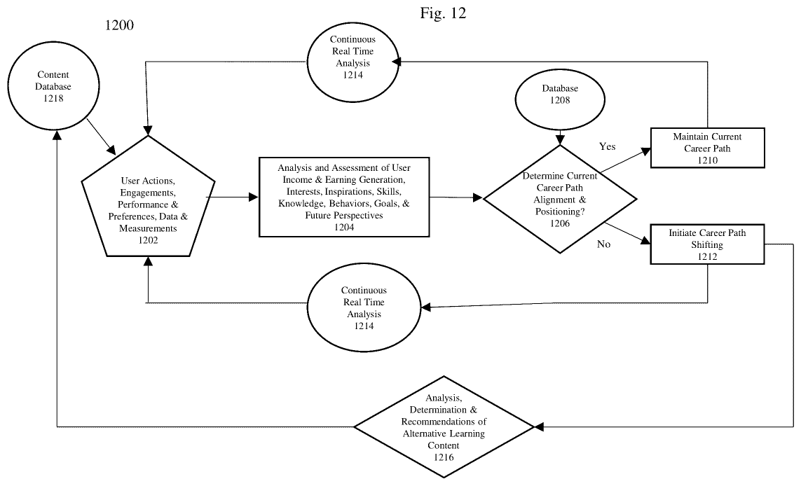

Exemplary FIG. 12 shows an exemplary method for career development, work readiness, income generation and financial management.

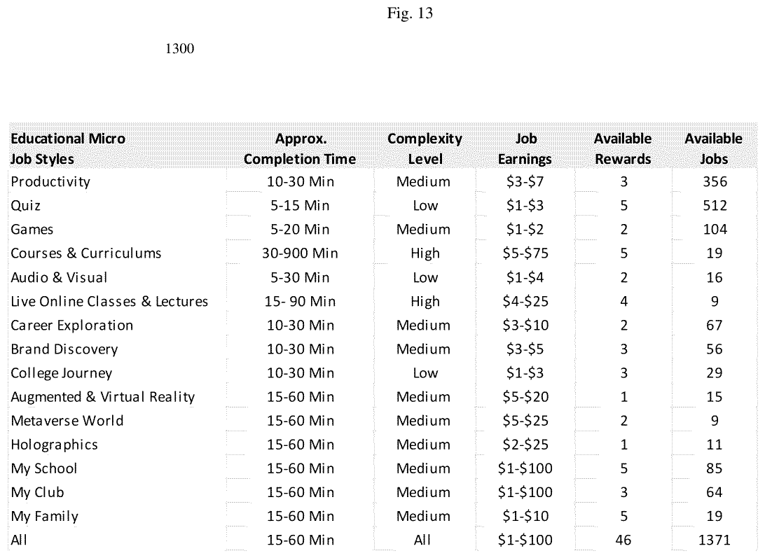

Exemplary FIG. 13 shows an exemplary table for job payment.

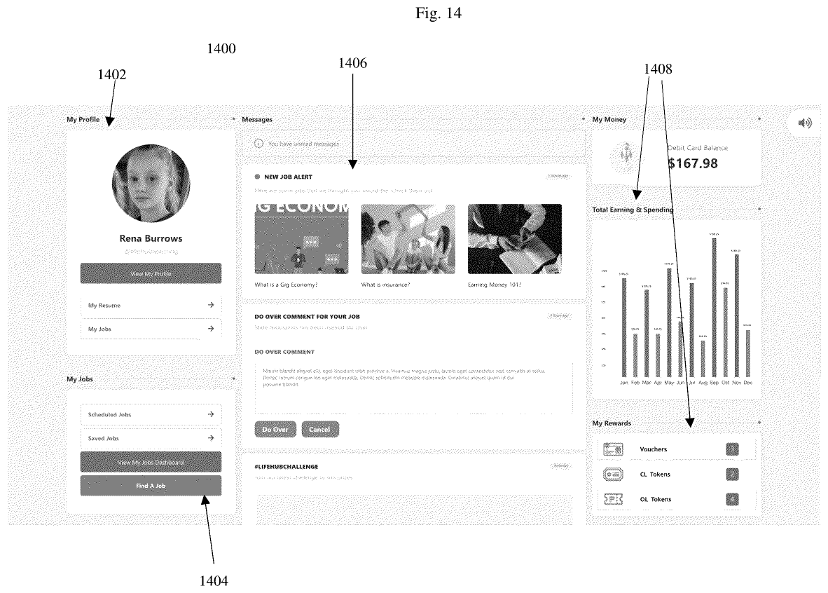

Exemplary FIG. 14 shows an exemplary landing dashboard panel.

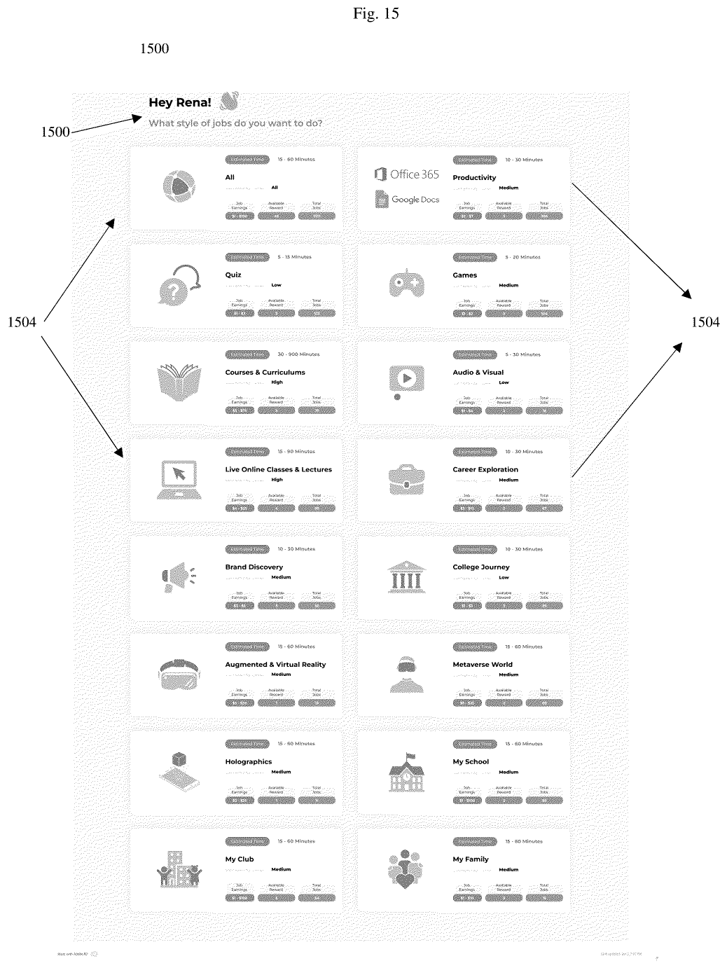

Exemplary FIG. 15 shows an exemplary job style panel.

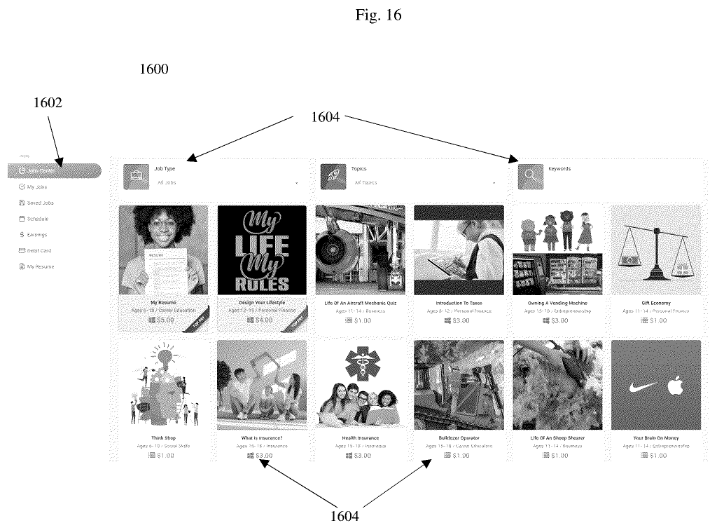

Exemplary FIG. 16 shows an exemplary job center panel.

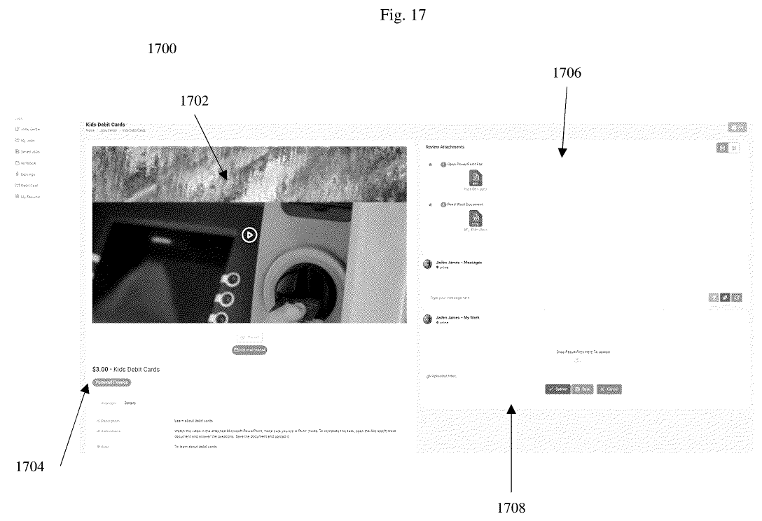

Exemplary FIG. 17 shows an exemplary productivity job panel.

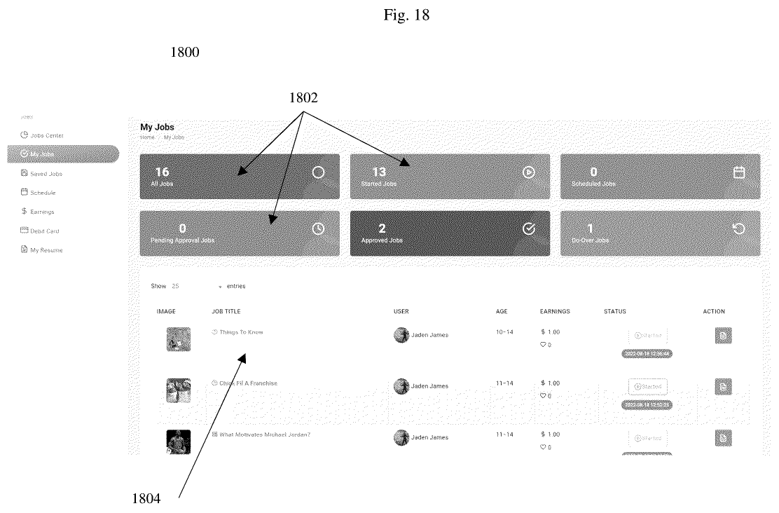

Exemplary FIG. 18 shows an exemplary my jobs dashboard.

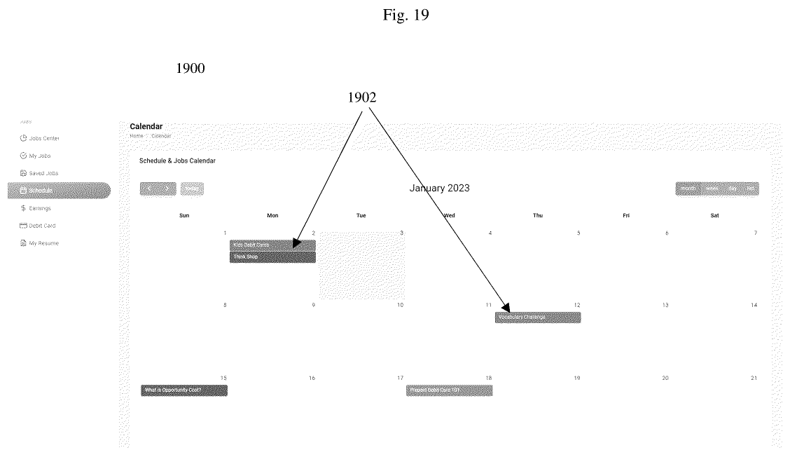

Exemplary FIG. 19 shows an exemplary interactive calendar.

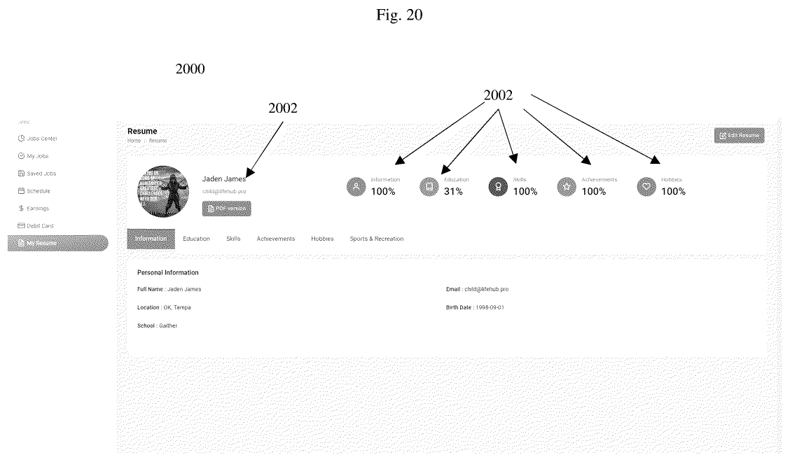

Exemplary FIG. 20 shows an exemplary resume dashboard.

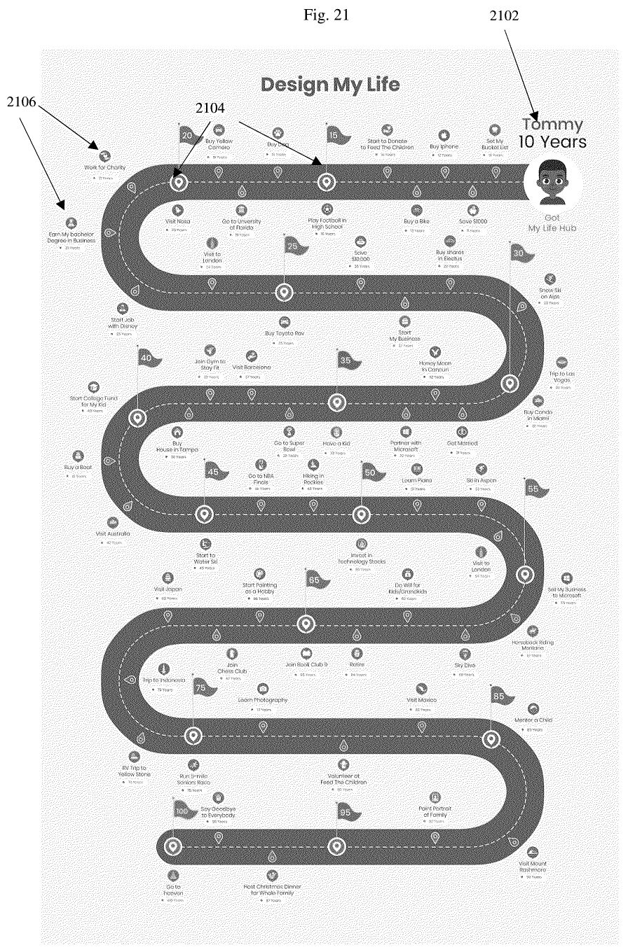

Exemplary FIG. 21 shows an exemplary design your lifestyle job.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

As used herein “early age career development and work-readiness” are learning activities and/or experiences that may provide young people with the ability to learn and acquire the skills, knowledge, and behaviors they need to help them make proper career connections, and suitable career choices, and decisions.

As used herein, the term “income and earnings generation” means the acquisition through payments of real monetary earnings and non-monetary rewards for the performances of educational micro jobs through work-to-earn opportunities and learning engagements on the system.

As used herein, the term “monetary earnings and non-monetary rewards” refers to real-world cash and cash credits on, for example, loadable debit cards and digital badges, certificates, e-gifts, e-vouchers, open-loop tokenization, and closed-loop tokenization respectively.

As used herein, the term “educational micro jobs” refers to short educational jobs or tasks performed via the internet on the system and presented through a wide variety of learning types, styles and environments, including but not limited to, productivity, quizzes, courses, curriculums, programs, games, audio/visual presentations, augmented reality, virtual reality, live online interactions, holographic and metaverse. Educational micro jobs may be based on a wide variety of academic, non-academic, and real-world subjects and topics, including but not limited to, armed forces, volunteering, automotives, business, climate, economics, entertainment, entrepreneurship, fitness, geography, health, life sciences, planet, sports, medicine, public service, private enterprise brands, higher education, personal finance, career development, work-readiness, mathematics, politics, and technology. Educational micro jobs may be used interchangeably with “micro jobs”, “jobs”, “edu-job” or “educational tasks”. Educational micro jobs may range from, for example, 5 to 900 minutes.

As used herein peers may be educators, mentors, school managers, or other individuals who participate in the system by managing, controlling, and monitoring a student's engagement and learning on the system. Peer roles may be provided to individuals by administrators.

As used herein the term “career mapping” means the visualization of the established or setting of career objectives, goals, and future perspectives and the strategies and actions that need to be undertaken to attain those career objectives, goals, and future perspectives.

As used herein “future perspective” means the degree to which the chronological future is integrated into present lifespan of the user through motivational goal-setting processes.

As used herein “behavior” and “behavior formation” are terms used to describe actions or sets of actions exhibited by the user that may either positively, negatively, or neutrally be associated with learning outcomes in a statistical or quantitative sense and/or non-statistical, subjective, or qualitative sense.

As used herein “adaptive learning” is an educational methodology that deploys and utilizes algorithms to coordinate learning interactions with the user and provide customized learning resources, material and content for learning activities and engagements to meet the individualized needs of the user. It may be understood that systems and methods described herein may utilize adaptive learning and teaching that, in part, can capture data to analyze, curate, modify, present, personalize, and visualize career development, work-readiness and financial management learning material and content based on user's historical engagements, preferences and performances to achieve optimal learning content individualization, adaption and customization.

As used herein “prescriptive analytics and analysis” is the process by which past or historical career development, work-readiness, income generation and financial management engagements, performances and preferences data are utilized to determine a new optimal course of learning actions and activities that yield a new way-forward recommendations of such.

As used herein “predictive analytics and analysis” is the process by which predictions of future performances of career development, work-readiness, income generation and financial management are made by analysis of past or historical career development, work-readiness, income generation and financial management engagement and learning performances.

In some embodiments career mapping may have four or more components including, for example, self-assessment, career exploration, career identification and discovery, and career selection and planning. In some embodiments prescriptive analytics, artificial intelligence (AI) and machine learning (ML) may be implemented and deployed to generate optimal personalized learning experiences to assist in the user's career planning, and path decisions and selection as well as work-readiness planning during the work-to-earn engagements, performances and learning opportunities, activities, and processes on the system.

Career development and work-readiness engagement and learning may further help develop career motivations, and aspirations by enabling the user to broadly consider a multitude of options that are available without restricting or limiting personal and professional goals, aspirations and futures perspectives or possibilities. In some embodiments educational and learning paths may support the process of career exploration and discovery which may lead to the election of more suitable career paths by a user to achieve the user's professional and life aspirations and goals.

In some embodiments early age experiential training, real-world learning, and experiences in work-to-earn, learn to earn, generating real income, earning real money, and managing personal finances may empower the user to learn and acquire the earning and money management skills, knowledge, and behaviors they need that will directly impact their ability to effectively manage their lives professionally and personally.

In some embodiments career development, work-readiness and/or early age experiential training, real-world learning, and experiences through work-to-earn, learn-to-earn generating real income, earning real money, and managing personal finances may be implemented through and/or powered by predictive analytics, prescriptive analytics, AI and ML.

Throughout the embodiments non-monetary rewards may include digital badges and certifications.

Digital badges and certifications may be digital proof of educational and life accomplishments, achievements and recognitions that encourage participation and promotes motivation in students. Digital badges and certifications may be rewarded to the student for accomplishments or achievements that are tied to mastery and proficiency in acquired skills, and knowledge. In some embodiments badges and certifications may be earned, collected, and amassed in a portfolio or library of digital badges and certifications. Digital badges and certifications may include, for example, but not limited to, number of jobs completed, number of a category of jobs completed, for example “Career Prep-Medicine” consisting of five distinct individual Educational Micro Jobs including Optometrist Career, Orthodontist Career, Pharmacist Career, Surgeon Career, and Chiropractors Career Educational Micro Jobs. Other examples of group Educational Micro Jobs may include, for example Entrepreneurship Prep-Level 1, Financial Literacy Prep-Level 1, Microsoft Beginners, etc. Other accomplishments and achievements may include a defined amount of monetary earnings earned, defined total engagement time, defined single module completion, defined group module completions, defined single and/or group course, curriculum and program completions and other programs that meet national educational standards, etc.

In other embodiments non-monetary rewards may include digital points rewarded to the student for educational and life accomplishments, achievements, and recognitions. The digital points may be amassed in a portfolio or library which can be converted to monetary earnings or cash based on defined set of conversion criteria and rates.

In an exemplary embodiment a first method for mapping out a user's learning path may be provided, which may provide a way for the users to explore, discover and select career paths to map out their learning paths for skills development, knowledge acquisition, and behavior formation to reach their optimal career, work-readiness, and life success as well as achieve goals and ambitions.

The first exemplary method to map out the user's learning path may be to work backward from the careers that most interests the user and then allow the user to explore and discover the skills, knowledge, behaviors, competencies and educational requirements and qualifications each of those careers requires. This may then lead to the designing of tailored learning pathways in order to acquire those requisite skills, knowledge, behaviors, competencies, and educational qualifications to secure employment in those desired careers, the results of which can then be analyzed, measured, assessed, and visualized by predictive analytics, prescriptive analytics, AI and ML.

In an exemplary embodiment a second method for mapping out a user's learning path may be provided, which may provide a way for users to explore, discover and select career paths to map out their learning paths for skills development, knowledge acquisition, and behavior formation to reach their optimal career, work-readiness, and life ambitions.

A second method or way to map out the user's skills development, behavior formation and learning paths may be to allow for broad exploration, and engagement in career awareness, discovery, knowledge and learning and which may then allow for assessments, by predictive analytics, prescriptive analytics, AI and ML of their own abilities, skills, interests, aptitudes, knowledge, inspirations, and motivations to determine the careers and careers paths that are best suited for the user and recommend the educational programs and qualifications that will give the user the greatest opportunity to secure employment within those prescribed career paths. Predictive analytics, prescriptive analytics, AI and ML may be utilized to analyze, measure, assess, visualize and predict the user's abilities, skills, interests, aptitudes, knowledge, inspirations, and motivations to determine optimal career elections, decisions, and paths.

In some embodiments the system may perform career matching for a student. Optimal career matches may be surfaced or identified through user's known personality type including, for example, realistic, investigative, artistic, social, enterprising and conventional personality types. AI and ML engines may be utilized to match specific careers and/or career clusters based on user's personal strengths, interests and display educational micro jobs that are related to those specific careers and/or career clusters. As examples, Al and Ml engines may identify and display educational micro jobs for user with realistic interests from career clusters that include agriculture, food, and natural resources, architecture, and construction or career clusters that include health sciences, information technology and law for user with investigative interests, or career clusters that include arts, education, and human services for user with artistic interests, or career clusters that include marketing, sales, and public administration for user with social interests, or career clusters that include finance, hospitality and business for user with enterprising interests, or career clusters that include manufacturing, transportation and finance for user with conventional interests. In other embodiments the specific jobs matched may be understood to vary over time based on the AI and ML engines.

In some embodiments, the system may combine and integrate career development, work-readiness, income and earnings generation and financial management experiential learning engagements, educational tasks, jobs, and activities and planning to optimize learning efficacy and efficiency to develop career development, work-readiness, income and earnings generation, and financial management skills, knowledge, behaviors, interests, aptitudes, inspirations, and future perspectives in the users.

In some embodiments the system may facilitate the user to develop and learn income and earning generation and financial management skills, knowledge, and behaviors by experientially performing educational micro jobs that may trigger the payment of monetary rewards and/or non-monetary rewards to the user for real-world spending and consumption. Educational micro jobs are presented on Jobs Center, comprising of an expansive collection of educational micro jobs designed and created by educators, mentors, parents, and subject matter experts, and having large variety of educational micro job types and styles, including for example, productivity, audio/visual, quizzes, courses, curriculums, live classes and online lectures, programs, games, career exploration, metaverse world, holographic displays, school club and family based activities, and/or virtual reality that center around variety of academic, non-academic and real-world subjects and topics.

Productivity tasks may be understood to be tasks that use productivity suites and tools. Productivity suites and tools may be understood to mean tools that help organization, analysis, and/or manipulation of numerical data and/or textual information that can be associated with the earning and payment of monetary and non-monetary rewards. Examples may include, for example but not limited to, text programs, spreadsheet programs, cloud-based document programs, etc.

Game based learning may be understood to be a teaching method that utilizes game characteristics and principles within learning activities to engage, motivate and teach that can be associated with the earning and payment of monetary and non-monetary rewards. Educational games feature elements such as rules, goals, interaction, instant feedback, problem-solving, competition, story, and fun. Educational games provide the opportunity to experience learning in a multi-sensory, active, and experimental environment. Games may be educational games centered around a variety subjects, including but not limited to, math, numeracy, science, and language where child plays educational games to earn monetary earnings and non-monetary rewards based on a set of defined and configured scoring matrices.

Interactives quizzes may be understood to mean short form tests that are utilized to assess and test knowledge acquisition that can be associated with the earning and payment of monetary and non-monetary rewards. In some embodiments quizzes may incorporate video and/or audio presentations.

Courses may be understood to be a set of online lectures that consists of several types of content, including but not limited to, videos, documents, and presentations. Curriculum may be a series of courses designed to help a child reach a certain defined level of knowledge and skills that can be associated with the earning and payment of monetary and non-monetary rewards. Course or curriculum micro jobs may be centered around a variety of subjects, for example but not limited to, financial literacy, entrepreneurship, and career development. Rewards may be earned by a student completing some or all of the course or curriculum and/or scoring above a threshold on a scoring matrix associated with the course or curriculum.

Audio and video learning may be understood to be the delivery of learning content using sound (auditory stimuli) and sight (visual stimuli). Audio and Visual content material may include a variety of content, for example but not limited to, interactive boards, computer graphics, videos, presentations, and audio material that can be associated with the earning and payment of monetary and non-monetary rewards.

Live online classes and lectures may be understood to mean the delivery of education via live video feeds utilizing meeting software on the internet in a one-on-one or group environment. Live Online Classes and Lectures may be conducted in combination with video recordings and/or as direct live interactions with participants that can be associated with the earning and payment of monetary and non-monetary rewards.

Career exploration may be understood to mean content that is utilized to explore and learn about the different types of careers, trades, and occupations, learn how to gain job experience, and/or discover educational opportunities to support career development and readiness that can be associated with the earning and payment of monetary and non-monetary rewards.

Brand discovery may be understood to me learning content that is utilized to discover, develop, and/or learn about commercial brands to achieve brand knowledge and awareness that can be associated with the earning and payment of monetary and non-monetary rewards. Brand Discovery may enable the learning of marketing and advertising as part of entrepreneurship education.

College journey learning may be understood to be learning content that is utilized to discover and learn about the different types of college degrees and the colleges that provide those degrees, for example tasks around the discovery of college degrees and colleges including course catalogs and virtual tours that can be associated with the earning and payment of monetary and non-monetary rewards.

Augmented, virtual reality, or holographic tasks may utilize and apply augmented reality, virtual reality, and holographic technologies to the delivery of academic, financial, entrepreneurship, career, and life education that can be associated with the earning and payment of monetary and non-monetary rewards.

Metaverse tasks may utilize and apply metaverse technologies for the delivery of academic, financial, entrepreneurship, career, and life education that can be associated with the earning and payment of monetary and non-monetary rewards.

In some embodiments jobs may be designed and published by one or more third party groups. For example, a series of tasks may be “my school” tasks, in which a school associated with the student designs and publishes one or more jobs for the student. In some embodiments these tasks may be visible to all students associated with the school. Likewise other series of tasks may be designed for a particular club, or by a family specifically for family members, for example a parent designing one or more jobs for one or more children.

Jobs may be presented in a variety of forms, including but not limited to, productivity suites, an accordion format (vertically stacked expandable items), an advent calendar, Agamotto (a series of images displayed sequentially), as courses or curriculum, as live classes, as rebus (puzzles with words represented by combinations of pictures and individual letters), as games, as multiple answer quizzes, as assays, through augmented reality, virtual reality, metaverse, or holographs, through arithmetic quizzes, audio recording, charts, collages, columns of information, crosswords, dialog cards, dictations, through documentation tools, through drag and drop tasks with images or words, through essays, through fill in the blank tasks, through find image hotspots, through find the word grid games, through flashcards, through guess the answer questions, through interactive images such as find the image or image sequencing, through interactive books, through true false questions, etc.

Jobs may include a variety of topics, including but not limited to, the armed forces, astronomy, automotives, aviation, biology, business, career development, chemistry, climate sciences, communications, economics, literature, entertainment, entrepreneurship, environmental sciences, fitness, geography, government studies, health, history, life sciences, marine life/biology, mathematics, medicine, public service, social skills, sports, volunteering, or any other topic.

In an exemplary embodiment the collection of educational micro jobs may be adapted and presented to the user based on the user's educational micro job type and style preferences, as determined by, for example, prescriptive analysis. The user's educational micro job type and style preference may be determined based on a plurality of factors, including, but not limited to, age, grade-level, level of comprehension, strong interests in certain topics and subject matters, and learning styles or methods preferences, including visual, auditory, and read/write or in combination. The system may utilize prescriptive analytics, AI and ML to track the user's engagements, actions, preferences and performances as the user's interact with the system and implement customizations and individualization methods for delivery and presentation of personalized learning content, including educational micro jobs presented in a variety of forms, including but not limited to, productivity, audio/visual, quizzes, courses, curriculums, live classes, programs, games.

In an exemplary embodiment the prescriptive analytics, AI and ML may analyze, measure, assess and visualize the user's work-to-earn, income and earning generation as well as financial management activities, engagements, and performances to determine the user's present abilities, skills, knowledge, and behaviors levels to formulate an understanding of user's abilities, skills, knowledge, and behaviors levels, with the operation of continuous analysis, measurement, assessment and visualization, by prescriptive analytics, Al and ML, over extended period of engagements and performances to determine newly observed increase or decrease in inspirations, motivations, actions, activities, engagements and performance results that could indicate skills, knowledge development and behavior formation pertaining to work-to-earn, learning, income and earnings generation and financial management.

In an exemplary embodiment the system may facilitate the users to learn and develop professional, trade, career path interests, aspirations, skills, knowledge, behaviors and future perspectives as well as work-readiness skills, knowledge and behaviors by performing learning jobs and tasks individually associated with work-to-earn, career development and work-readiness, including but not limited to, a wide variety educational micro jobs to earn monetary earnings and non-monetary rewards associated with desired trades, professions, and careers including, for example, designing and maintaining resumes, engaging with career searches and advisory by human expert and/or system for career exploration, performing college and degree research and reviews, private enterprise and brand discovery.

In an exemplary embodiment, prescriptive analytics, AI and ML may intelligently analyze, measure, assess, visualize and predict user's career and work-readiness abilities, skills development, behavior formation, habits, interests, aptitudes, knowledge, inspirations, and motivations to determine aptness and suitability of defined career elections and choices and/or determine potential suitable career elections and choices based on analyzed, measured, assess and visualized career development and work-readiness abilities, skills, behaviors, habits, interests, aptitudes, knowledge, inspirations, and motivations. In an exemplary embodiment, prescriptive analytics, AI and ML may also continuously analysis, measure, assess and visualize learning engagements and performances over an extended period of time to determine newly observed increases or decreases in inspirations, motivations, actions, activities, engagements, and performance results that could indicate skills, knowledge development and behavior formation pertaining to work-to-earn, career development, work-readiness which may ultimately predict career potential outcomes and success.

In an exemplary embodiment there may be one or more methods for future perspectives and goal setting. In some embodiments future perspectives may influence users because users with precise visions and goals about their professional future may be more capable of responding by positively enacting career and workplace solutions through core aspects. The core aspects may include, but are not limited to, positive personal characteristics for attitude maturity, self-resilience, adaptability, self-direction, self-knowledge, and personal development; organizational acumen includes motivation, maturity, awareness, professionalism or work ethics, social responsibility, and general attitude to work; work competence for practicality, attitudes, knowledge, and skills in work which may include work motivation, problem-solving, critical thinking, and creative thinking; and social intelligence for effectively managing social relationships with others in their environment, including teamwork, social skills, adaptability, and interpersonal communication skills.

In some embodiments the system may enable the user to define, establish, and/or set career, professional and work-readiness aspirations, ambitions, goals, and future perspectives presented over the user's present life as well as lifespan and whereby, by prescriptive analytics, AI and ML, intelligent analysis and evaluations of the user's learning engagements, performances and preferences are performed to determine progress of the user as well as assess and predict the probability of future career and work-readiness performance and success. User performance may mean, for example, but not limited to, determining if the user is, succeeding, lagging, or failing towards fulfilling and achieving present and/or near-term career, work-to-earn, professional and work-readiness aspirations, goals, and future perspectives; progressing on a positive and favorable trajectory or trend towards fulfilling and achieving medium and long-term career, professional and work-readiness aspirations, goals, and future perspectives; frequently engaging in income generation tasks and activities and/or generally building positive personal characteristics, organizational acumen, work-readiness competencies and social intelligence.

In an exemplary embodiment, behaviors and behavior formation may be determined by analysis and processing measurements of data, by AI and ML, collected about the user's engagements, performances and preferences while the user is interacting with learning materials and content on the system, aggregated by Al and ML to determine indicators of performance, success, failure, and preferences. Examples of behaviors and behavior formation may include, but are not limited to, high or low levels of engagement, high or low levels of educational micro job completions, high or low levels of career and work-readiness subject matter searches and reviews. Other examples of analysis, measurement, assessment, and visualization of behaviors and behavior formation in quantitative sense, include but are not limited to, frequency of engagements, duration of engagements, and high or low work-to-earn levels, levels of income and earnings generation, and high or low levels of spending and personal consumption. Examples of analysis, measurement, assessment, and visualization of behaviors and behavior formation from a qualitative orientation, include but are not limited to, user feedback analysis, parent, educator, and mentor feedback analysis, and user learning content, material ratings and learning experiences rating performances on the system. Behaviors and behavior formation may be used to model the user, compare the user to one or more other users, or compare the user to the same user's actions, activities and behaviors in prior learning engagements and performances, or multiple of the above, and may adjust learning content delivery based on identified preferences and on known successful approaches for different behaviors.

In an exemplary embodiment, prescriptive analytics, AI, and ML may be utilized and deployed for user modeling. User modeling may be utilized for evaluating, appraising, and shaping the user's interests, aspirations, motivations, goals, future perspectives, knowledge and skills through the analysis, measurement, assessment and visualization of the user's historical learning engagements, performances and preferences pertaining to the user's work-to-earn, income and earnings generation activities, spending and personal consumption activities as well as career and work-readiness learning activities.

The user's actions and engagements may be identified, captured, and recorded in real-time as they occur. User's actions and engagements may include, but are not limited to, educational micro jobs starts, educational micro jobs completions, educational micro jobs do-overs and remediations, income and earnings generations, spending and personal consumption, time searching and reviewing specific trades, career and work-readiness subjects or topics searches and reviews, private enterprise and brand searches and reviews, private enterprise and brand exploration, document, image, video, audio material reviews, productivity suites and tools utilization, educational micro job types selections, educational micro job style selections, academic institutions research and reviews, academic certifications and degree searches and reviews, educator, mentor, and parent engagements and communications on the system, establishment and setting of goals, correlations between the user's established goals and chosen learning engagements, paths and performances, future perspectives and general engagement levels, including but not limited to, frequency, and duration of engagements and learning.

A user model may be created for each user and the model may be designed and modified through analysis of all or a subset of the skills, knowledge, and behaviors the user displays, derived from their measurements generated by AI and ML, through the user's learning engagements, performances and preferences. The user model may formulate an understanding of the user's present-day skills, knowledge, behaviors, preferences, as well as on a continuous basis and predict future behaviors and performances. As the user progresses through career and work-readiness learning engagements as well as work-to-earn, income and earning generation opportunities and activities through the performance of educational micro jobs, the user's understanding and knowledge of work to earn, career development, and work-readiness and their values, attainments and requirements, as well as income and earnings generation skills and behaviors may be tracked by the user model, by prescriptive analytics, AI and ML. Over time, the user model may evolve and become more useful with more data, thereby, in part, may more accurately personalize learning content and materials, recommend more suitable career paths and better predict future work-readiness performances and career success.

Through utilization of prescriptive analytics, AI and ML, the user's career path shifts may be recommended, inspired, and initiated by the user. Career path shift may result in a change or shift in the user's career and work-readiness aspirations, goals, and future perspectives. That change or shift may induce a change or shift in the user's career learning interests, engagements, learning content and material preferences.

In an exemplary user model outcome, the user model may assess, determine, and visualize the need for career path shift attributable to the user's change or shift in learning content interests, preferences, engagements and performances on the system, including but not limited to, educational micro jobs selections, educational micro jobs performances and completions, increase or decrease in income and earning generation, educational micro jobs searches and reviews, learning performances and content selections pertaining to career and work-readiness subject matters and topics and searches, and private enterprise and brand searches, reviews and content engagement. Changes may be attributable to, for example, the user's loss of interest and/or enjoyment in pursuing current learning path based on current desired career and work-readiness aspirations, goals, and future perspectives.

In another exemplary user model outcome, the user model may determine assess and visualize that the user may benefit from one or more similar but alternative career and work-readiness paths and then recommend the appropriate and suitable career and work-readiness learning and material content and engagements for those similar but alternative career and work-readiness learning paths to increase the user's knowledge, skills, competencies and understanding of those similar but alternative career, and work-readiness, including but not limited to, employment requirements and qualifications and college options and degree requirement.

Referring FIGS. 1-13, the Figures may show examples of systems and methods utilizing some of the above described concepts and techniques.

Referring now to FIG. 1, FIG. 1 is an exemplary educational micro jobs system 100. The educational micro jobs system 100 may be, for example, a management server. The education micro jobs system may include a processor 104, a database storage 106, and a transaction processor 108. In some embodiments one or more third party platforms APIs 110 may further be integrated with the system 100. The system 100 may further include a plurality of API's or interfaces, for example a parent interface 120, educator interface 122, child interface 124, a job designer or coach interface 126, a benefactor interface 118, etc. A plurality of display devices within a network 130, which may be a cloud or wired network, may access the plurality of user API's or interfaces. The display devices may include, for example but not limited to, a mobile device 140, a laptop 142, a tablet 144, and/or a computer or desktop 146.

Referring now to FIG. 2, FIG. 2 is an exemplary process and operations flowchart for performing an education micro job 200. The process may start with initialization in step 202. In a first step 204 a student may login to the system. In a next step 206 the student may select find a job from a home or landing screen. In a next step 208 the student may select a job style, and from within the job style may select a job in step 210. In a next step 212 the student may save the selected job, and the job may then be stored in a favorites category or database in step 214. Alternatively, the student may schedule the job for a different date and/or time in step 216, and the scheduled job may be automatically sent to a calendar 218. In some embodiments the calendar may be an integrated calendar while in other embodiments the system may interface with an existing calendar. The job may then be started in step 220 after job selection and the student may perform the job according to selected parameters. In step 224 job scoring may be determined, some jobs may be scored automatically 226, for example by scoring against a matrix, and/or some jobs may be manually reviewed 228, for example by a coach. The job may then be considered completed 230, and if done correctly may be approved 234, while is done incorrectly a do-over may be triggered 232, or the student may otherwise be informed of the incorrectly completed job. If the job was approved in 234 then one or more rewards may be triggered in step 236, and then the approval (or a do-over notification) may be displayed on a dash or otherwise reported to the student. The one or more rewards may be monetary and/or non-monetary rewards and may be based on the job completed. After reporting the student may then return to step 222, for example in the case of a do-over or where another job is queued, if not further jobs or needed then the process may end at step 240.

Referring now to FIG. 3, FIG. 3 is an exemplary flowchart for designing, creating, and publishing productivity educational micro jobs. The process may start with initialization in step 302. In a first step 304 a job designer, job coach, educator, or parent may login to a job designer portal or job center. The job designer may create a name or title for a job in step 306, a description for the job in step 308, instruction for the job in step 310, job goals or complete conditions in step 312, and/or job tips or hints in step 314. The job designer may further upload one or more attachments or media to be associated with the job 316, for example word files, spreadsheets, presentations, video, audio, or other images. In a next step 318 visibility parameters may be set, for example students of a certain age, or that have completed certain other activities. In a next step 320 rewards may be set, including, for example, necessary parameters to obtain the rewards and the contents of the rewards. In a next step 322 communication parameters may be set, for example how the student may be contacted during the job and/or student contact permissions such as uploading. In a next step 324 the job inputs may be reviewed and submitted, and the job may be published to a job board 326. In some embodiments a published job may be edited 328 by returning to step 304. In a step 330 the job may be displayed on a job center where it may be selected by a student, and the process may end 332.

Referring now to FIG. 4, FIG. 4 is an exemplary flowchart for designing and publishing quiz educational micro jobs. The process may start with initialization in step 402. In a step 404 the job designer, job coach, educator, or parent may login to a job designer portal or job center. In a step 406 one or more questions may be created, and then a plurality of questions, either newly created or already existing, may be added as a series to constitute a quiz 408. In a next step 410 any additional media and answers for the plurality of questions may be added. In step 414 the quiz inputs may be reviewed and the quiz may be submitted. In a step 416 the quiz may be published and displayed to a job board. In some embodiments the quiz may be edited after published 418 by returning to step 404. In a step 420 the quiz may be published and displayed to the job center, and the process may stop 422.

Referring now to FIG. 5, FIG. 5 is an exemplary flowchart for assignment, payment, rewarding, and management of educational micro jobs. The process may start with initialization in step 502. In a step 504 a peer may login to a peer portal. In a step 506 one or more jobs to be assigned may be selected, and the student to be assigned the job(s) may be selected. In a step 508 one or more time constraints may be defined, for example number of days/weeks etc. to start the job, date range where the job can be accessed, and/or how long the student may spend on the job. In a step 510 rewards for the job may be defined and one or more time triggers for reward tiers may be defined 512. In an exemplary embodiment time triggers may be a time basis on which rewards are disbursed to a student, for example, instantly, hourly, weekly, monthly, etc. In a step 514 one or more additional custom parameters may be defined, and the student may be notified that the specialized job has been created 516. The notification may be, for example, an email, push notification, text, message on the student profile, etc. The job may then be initialized 518 and displayed to the student 520, and the process may stop 522.

Referring now to FIG. 6, FIG. 6 is an exemplary flowchart shows an exemplary flowchart for registering a student. The process may start with initialization in step 602. A peer may login to a peer portal in step 604. In step 606 individual or group registration may be selected. Registration may include manually inputting individual or group information 608, by uploading data 610, for example an excel or work sheet, and/or through database integration 612. Database integration may be, for example, connection to a school database. In a step 614 registration may then be initialized, and the process may stop at 616.

Referring now to FIG. 7, FIG. 7 is an exemplary process and operations flowchart for triggering, crediting, storing, and managing student earnings. The process may start with initialization in step 702. In a step 704 a student may complete a job and the job may be approved. In some embodiments non-monetary reward earning payments may be triggered based on the completed job 706 and may be applied to the student's account 708. The rewards may be stored in an account associated with the student 710 and/or may be, either immediately or at a later time, converted or consumed 712. The process may then stop.

In some embodiments monetary earnings may trigger payments to the student 716. In a step 718 a time frame and amount of credit may then be determined based on the completed job and performance or other factors. In a next step 720 the rewards may then be credited and displayed to the student's account, and available earnings amount may be displayed 722. In some embodiments in a step 724 a notification may be sent to a transaction processor according to the credit amount determined in step 718. The student may then be able to purchase goods and/or services based on their credits 726, and any purchase transactions may be displayed and/or recorded to the student's account. Finally, the transaction amount may be detected from the student's total earnings amount 730 and unspent earnings may be displayed 730, the process may then stop at 732.

Referring now to FIG. 8, FIG. 8 is an exemplary process and operations flowchart for evaluating productivity style performance. The process may start with initialization in step 802. In a step 804 a student may login to a student portal. In a next step 806 the student may search for a job by selecting a productivity tools style, for example game, quiz, course, etc. The student may then be able to review the productivity media through a website or via integrated productivity suite and tools solution built into the portal 810. In a next step 812 the student may perform the job through the portal and then submit the job 814, and the process may stop 816. In some alternative embodiments the student may instead download the productivity media 820 and perform the job locally 822. After job completion the student may then upload job documentation 824, for example answers to questions, and submit the job 826, the process may then end 826.

Referring now to FIG. 9, FIG. 9 is an exemplary flowchart for generating and downloading summaries and comprehensive reports. The process may start with initialization in step 902. At step 904 an admin may login to an admin portal. In a next step 906 the admin may select one or more report parameters, for example, earnings, time and date, report type, etc 906. In a next step report type may be selected, for example a summary report 908 or a comprehensive report 910. In a next step 912 one or more additional filters may be selected, for example organization 916, student 918, or jobs 920. The report may then be selected based on the filter, for example a total report 914, an organization report 922, a student report 924, and/or a job report 926. The report may then be downloaded 930 and the process may stop 932.

Referring now to FIG. 10, FIG. 10 is an exemplary process and operations flowchart for evaluating performance of quiz education micro jobs. The process may start with initialization in step 1002. In a first step 1004 a student may login to a student portal. In a next step the student may select find a job 1006 and may select a quiz style job 1008. From within the quiz style job list the student may then select a specific quiz 1010. The quiz may then be started at 1012 and evaluated for correctness at 1014. There may be a specific criterium for correctness, for example a certain percentage correct and/or completion within a certain amount of time. In some embodiments there may be multiple tiers of correct completion, for example an “A”, a “B”, etc. In some embodiments different payouts may be rewarded for different thresholds, e.g. 100% payment for getting all questions correct, 70% payout for getting between 70-100% correct, etc. The thresholds may differ depending on the number of questions in the quiz. If the quiz is not completed correctly the quiz may be marked incomplete or a do-over may be triggered 1016. Furthermore, the system may transmit a fail message at 1018, the fail message may be, for example, a prompt to try again, a sad emoji or other symbol, hints or tips, etc. The student may then be able to, immediately or later, retry the quiz. If the quiz is completed successfully then the job may be approved at 1022. The student may then be rewarded the appropriate credits or rewards 1024 and a success message may be displayed. The success message may be, for example, a confetti burst, a happy emoji, and/or a congratulatory message.

In some embodiments quizzes may provide immediate feedback after each question, for example when a question is correct the student may get a positive notification such as a confetti burst or a message such as “Congratulations! Your answer is correct.”. In the case of an incorrect question the student may receive a notification such as a sad emoji or “Opps! Your answer was incorrect. Please try again.”

Referring now to FIG. 11, FIG. 11 is an exemplary system for digital transfer of cash or money 1100. One or more of a family bank or credit info 1102, an Administrator bank or credit info 1104, an organization bank or credit info 1106, or a benefactor bank or credit info 1108 may be connected via a third party transaction API 1110. The third party transaction API may transfer the information to a system processor 1112 and a system database 1114, where the debit earnings may then be displayed on one or more of a student dashboard 1116, an organization dashboard 1118, an administrator dashboard 1120, a parent dashboard 1122, and/or a benefactor dashboard.

Referring now to FIG. 12, FIG. 12 is an exemplary method for career development, work readiness, income generation and financial management 1200. In an exemplary embodiment the method 1200 may begin with user actions, engagements, performances, and preferences being fed into the system in a first step 1202. In a next step 1204, the method 1200 may involve analyzing and assessing, for example by prescriptive analytics, AI and ML, user income and earning generation, interests, inspirations, skills, knowledge, behavior goals, and future perspectives in order to determine alignment and positioning of the user's current career path. In a next step 1206 a database 1208 may be utilized to determine if the user career path alignment and positioning match with their planned career path. If career path alignment and positioning match then in a next step 1210 the current career path may be maintained. However, if career path alignment and positioning do not match and are in misalignment, a career path shift may be initiated in step 1212. Regardless of which path is taken, continuous real-time analysis may be implemented in step 1214 in order to continuously monitor the user's learning performance and progress on their chosen career path. If a career path shift was implemented then in a next step 1216, AI or ML may be utilized to analyze and make determinations and recommendations of alternate learning content that may be utilized by the user, which may be fed into a content database 1218 that contains information on the current career learning path being utilized by the user. The method may then return to step 1202 and continuously analyze the user's engagements, performances, and preferences.

Referring to FIG. 13, an exemplary table for job payment 1300 may be shown and described. in some embodiments tasks rewards may be determined based on one or more factors including, for example, job style, estimated completion time, complexity level, video or audio content playtime, number of items that need to be completed, number of documentations that need to be reviewed, required communications with mentors or educators, required research, etc.

Referring to FIGS. 14-20 an exemplary embodiment showcasing some of the systems and processes above may be shown and described.

In some embodiments an account may be tied to each student, and each account may contain student information, for example a login, password, student age, student grade level, student image, student name, student email address, etc. The account may be further tied to a portal which may be accessible by a network-connectable device, for example a phone, laptop, desktop, etc.

Referring to FIG. 14, a landing dashboard panel 1400 according to an exemplary embodiment may be shown and described. The landing dashboard panel 1400 may allow for navigation among one or additional features, for example editing profile 1402, requesting online support, updating a resume, viewing completed jobs 1404, scheduled jobs, or saved jobs, responding to comments from administrators or educators such as coaches 1406, earnings and rewards 1408, etc.

Referring to FIG. 15, a job style panel 1500 according to an exemplary embodiment may be shown and described. The job style panel may include a personalized message for the student 1502. The job style panel 1500 may further include one or more interactive graphical boxes 1504 that display, for example, a graphical icon, job style name, earnings or earnings availability, the number of the corresponding type of job available etc. The panel may allow for selection and navigation to one or more jobs of the selected type.

Referring to FIG. 16, a job center panel 1600 according to an exemplary embodiment may be shown and described. The job center panel may include one or more menu options 1602, for example jobs Center, My Jobs, Saved Jobs, Schedule, Earnings, Debit Card, My Resume, Job Type entry box, Topics entry box, and/or Keyword Search entry box 1604. The search boxes may allow for searching from among a plurality of available jobs, for example a plurality of jobs within a selected job style.

Referring to FIG. 17, a productivity job panel 1700 according to an exemplary embodiment may be shown and described. The productivity job panel 1700 may be displayed when a student selects a productivity job from the job center. The productivity job panel 1700 may display a video 1702 or other required educational material. The productivity job panel may further display the reward associated with the given job 1704, for example that once the current job is completed the student will receive $3 to an associated debit card. In some embodiments there may be an area that allows for the download and upload of documents 1706 or other files by the student. The productivity job panel 1700 may further allow for communication with others 1708, for example coaches or other educators.

Referring to FIG. 18, a my jobs dashboard 1800 according to an exemplary embodiment may be shown and described. The my jobs dashboard 1800 may contain a series of interactive graphical boxes 1802 that display data and information. The graphical boxes 1802 may include, for example but not limited to, all jobs, started jobs, scheduled jobs, pending approval jobs, approved jobs, and/or do-over jobs. The boxes 1802 may further display additional information inside, for example graphical icons or a numerical value corresponding to the number of jobs related to the graphical box. The my jobs dashboard 1800 may further include a table 1804 which may list one or more jobs with related display images, job titles, student names, age ranges, monetary earning, status, date and time stamps, etc.

Referring to FIG. 19, an interactive calendar 1900 according to an exemplary embodiment may be shown and described. In some embodiments one or more scheduled or saved jobs 1902 may be automatically synced with and displayed on the calendar 1900. The calendar may further be integrated with one or more other devices, and may send, for example, push notifications, texts, pop-up reminders, or any other reminder to the student based on scheduled or saved jobs.

Referring to FIG. 20, a resume dashboard 2000 according to an exemplary embodiment. The resume dashboard may include student information 2002 and one or more resume fields 2004, for example education, skills, achievements, hobbies, sports, and recreation. In some embodiments a percentage may be associated with each of the one or more resume fields, which may indicate how complete that section is with respect to a given resume. In some embodiments the resume may further be downloadable or shareable via, for example, email, SMS, etc.

In some embodiments a plurality of other tools or features may be further provided.

In some embodiments a career advisor tool may be provided. The career advisor tool may provide a student with career advice and/or recommendations based on one or more sets of collected and analyzed data, for example the student's historical performances of educational micro job types, styles, and a career test questionnaire to match student's educational outcomes, ambitions, background, personality with probable occupational and career direction. Conversely, the career advisor may surface and recommend jobs that are based on subjects and topics of the student's desired and defined career ambitions and aspirations. In some embodiments the career advisor tool may further utilize ML and/or AI.

In some embodiments a college advisor tool may be provided. The college advisor tool may provide a student with matchmaking and advice related to colleges, universities, and trade schools based on one or more sets of collected and analyzed data, for example the student's historical performances of educational micro job types, styles, and a career test questionnaire to match student's educational outcomes, ambitions, background, personality with probable occupational and career direction. The college advisor may provide determine career trends, gravitations, interests, and preferences, and/or provide insight into a student's career aspirations and inclinations. In some embodiments the career advisor tool may further utilize machine learning and/or AI. The ML and/or AI may map the above determines and utilize them to instantly matche the student's career preferences to colleges, universities and trade schools that provide educational programs, training, degrees, and certifications for those careers.

In some embodiments one or more tools for financial education may be provided. For example, an earnings advance feature where students may take an earnings “loan” which may then be repayed by performing one or more jobs. In some embodiments the loans may bear no cost including interest or fees, and may be understood to assist in teaching the student financial responsibility. In another embodiment a tool may be a credit scorer tool, which may collect, combine, and analyze historical data and information from child's monetary earnings, spending transactions and earnings advance activities and engagements to generate a credit score.

In yet other embodiments a tax center may be provided, which may enable a student to setup segregated buckets or folders to deposit and/or set aside a portion of their monetary earnings to pay associated state and/or federal income taxes for total annual earnings that meet or exceed thresholds for trigger tax liabilities. The tax center algorithm, which may utilize AI and/or ML, may analyze and calculate a student's tax liabilities based on the state in which the student resides, if any, and federal income tax guidelines and student total monetary earnings and may display the tax liabilities, if any, on a Tax Center dashboard.

In some embodiments an earnify tool may be provided. The earnify tool may be configured to interact with third-party platforms through an API, and allow transmission of data and information between the third party platforms and the system. Users on the third-party platforms, who are also students in the system, may earn monetary earnings and non-monetary rewards for completing tasks on third-party platforms and those monetary earnings may be credited to the child debit card on the system. The system may further be configured to receive and process data and information that is required to trigger, and credit monetary earnings and non-monetary reward to users as a result on completing tasks on third-party platforms.

Conversely, third-party youth-centric platform button may also be embedded on the System to enable users to access those third-party youth-centric platform as existing members or subscribers via the system so that successful performances of tasks and undertakings by users on the third-party youth-centric platform can be rewarded monetary and none-monetary rewards via the System.

In some embodiments students may be able to set one or more goals through a goal system, for example earning goals, job goals, saving goals, etc.

Referring to FIG. 21, In some embodiments a design your lifestyle job 2100 may be shown and described. The lifestyle job may designate a student and the students current age 2102. The lifestyle job may further include a plurality of age milestones 2104, which may be defined by, for example flags or another special symbol. The age milestones 2104 may include, for example, every 5 years, 10 years, etc. The student may insert a plurality of goals 2106. Goals 2106 may be any of a variety of goals, for example saving money, attending college, learning skills, etc. A target age or year may further be associated with each of the goals 2106.

In some embodiments students may be prompted to answer a plurality of questions centered around financial, career, life and personal subject matters which may be used to establish goals and timelines. In some embodiments questions may be customized or personalized by Peers and/or the student may create their desired questions. It may be understood that the design your life job may generate data and information that can be utilized to provide the student with enhanced learning experiences that deliver improved learning outcomes.

The foregoing description and accompanying figures illustrate the principles, preferred embodiments, and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method for career development comprising:
associating a user with a student account, the student account including at least user information;
assigning a plurality of educational jobs to the student account;
storing data related to user completion of at least one of the plurality of educational jobs assigned to the student account in a user content database;
scoring each of the at least one educational jobs completed by the user; and
triggering a reward to the student account based on the completion of the at least one educational job.

2. The method of claim 1, further comprising:
determining at least user actions, engagements, performances, and preferences tied to the student account by searching the user content database; and
analyzing, using artificial intelligence (AI) and machine learning (ML), at least the users actions, engagements, performances, and preferences to determine a career path alignment and position.

3. The method of claim 2, further comprising:
comparing the determined career path alignment and position to a career path database containing at least a planned career path associated with the user; and
determining there is a misalignment between the determined career path alignment and position and the planned career path.

4. The method of claim 3, further comprising:
determining, using AI and ML, at least one set of alternative learning content configured to correct the misalignment between the determined career path alignment and position and the planned career path; and
assigning one or more additional educational jobs to the student account based on the alternative learning content.

5. The method of claim 4, further comprising:
continuously polling at least user actions, engagements, performances, and preferences in real-time;
detecting further deviation from the determined career path alignment and position and the planned career path; and
notifying an administrator or the user of the further deviation.

6. The method of claim 1, wherein the educational jobs include at least one of a quiz, a curriculum, a course, a live online class, an educational game, and a career exploration task.

7. The method of claim 1, wherein the educational jobs include at least one of an augmented reality task, a virtual reality task, a metaverse task, and a holographic task.

8. The method of claim 1, wherein the reward is at least one of cash, cash credits, digital badges, certificates, e-gifts, e-vouchers, open-loop tokenization, or closed-loop tokenization.

9. The method of claim 6, wherein the educational jobs are designed by AI and ML.

10. The method of claim 1, wherein assigning the plurality of educational jobs to the student account includes at least one of automatically assigning the plurality of educational jobs by an assignment module, assigning the plurality of educational jobs by an educational coach or administrator, or the student assigning themselves the educational jobs by selecting a subset from all available educational jobs.

11. A system for career development comprising:
a communication device associated with a user and further associated with a student account, the student account including at least user information;
an educational jobs module which assigns a plurality of educational jobs to the student account;
a user content database which stores data related to user completion of at least one of the plurality of educational jobs assigned to the student account;
a scoring module which scores each of the at least one educational jobs completed by the user; and
a reward module which sends a reward to the student account based on the completion of the at least one educational job.

12. The system of claim 11, further comprising:
at user content module configured to determine at least user actions, engagements, performances, and preferences tied to the student account by searching the user content database;
and an analysis module configured to, using artificial intelligence (AI) and machine learning (ML), determine a user career path alignment and position using the at least the users actions, engagements, performances, and preferences.

13. The system of claim 12, wherein the analysis module is further configured to:
compare the determined career path alignment and position to a career path database containing at least a planned career path associated with the user; and
determine there is a misalignment between the determined career path alignment and position and the planned career path.

14. The system of claim 13, wherein the analysis module is further configured to:
determine, using AI and ML, at least one set of alternative learning content configured to correct the misalignment between the determined career path alignment and position and the planned career path; and
assign one or more additional educational jobs to the student account based on the alternative learning content.

15. The system of claim 14, wherein the analysis module is further configured to:
continuously poll at least user actions, engagements, performances, and preferences in real-time;
detect further deviation from the determined career path alignment and position and the planned career path; and
notify an administrator or the user of the further deviation.

16. The system of claim 11, wherein the educational jobs include at least one of a quiz, a curriculum, a course, a live online class, an educational game, and a career exploration task.

17. The system of claim 11, wherein the educational jobs include at least one of an augmented reality task, a virtual reality task, a metaverse task, and a holographic task.

18. The system of claim 11, wherein the reward is at least one of cash, cash credits, digital badges, certificates, e-gifts, e-vouchers, open-loop tokenization, or closed-loop tokenization.

19. The system of claim 16, wherein the educational jobs are designed by AI and ML.

20. The system of claim 11, wherein assigning the plurality of educational jobs to the student account includes at least one of automatically assigning the plurality of educational jobs by the educational jobs module, assigning the plurality of educational jobs by an educational coach or administrator, or the student assigning themselves the educational jobs by selecting a subset from all available educational jobs.
